(19) United States
(12) Patent Application Publication
(10) Pub. No.: US 2022/0050038 A1
(43) Pub. Date: Feb. 17, 2022

(54) Rheometer

(71) Applicant: BRABENDER GMBH & CO. KG, Duisburg (DE)

(72) Inventors: Oleg Krawez, Moers (DE); David Szczesny, Solingen (DE); Jörg Langwald, Duisburg (DE)

(73) Assignee: BRABENDER GMBH & CO. KG, Duisburg (DE)

(21) Appl. No.: 17/274,420

(22) PCT Filed: Sep. 10, 2019
(86) PCT No.: PCT/EP2019/074133

§ 371 Date: Mar. 8, 2021

(30) Foreign Application Priority Data
Sep. 10, 2018 (DE) 10 2018 122 023.5

(51) Int. Cl. G01N 11/14

(52) U.S. Cl. CPC G01N 11/14

(57) ABSTRACT

The invention relates to a rheometer (10) for determining the deformation and/or flow behavior of a test substance (30), comprising a measuring vessel (12) which is open towards one side (20) and which forms a cavity (28) in its interior for receiving the test substance (30), a measuring body (14) disposed within this cavity (28) and a shaft (16) connected to the measuring body (14) via the open side (20). It is provided that the measuring vessel (12) comprises a sleeve element (22) which extends from the side (26) of the measuring vessel (12) opposite the open side (20) into the interior of the measuring vessel (12), wherein the shaft (16) extends completely through the sleeve element (22).

The invention relates to a rheometer for determining the deformation and/or flow behavior of a test substance by means of a measuring vessel open towards one side, which forms a cavity in its interior for receiving the test substance, a measuring body arranged in this cavity and a shaft connected to the measuring body via the open side.

Such a rheometer is known from document DE 199 11 441 A1. This document describes a rheometer comprising a measuring cup, a measuring cylinder arranged in the measuring cup and a drive or output shaft which is connected on the one hand to the measuring cylinder via the open side of the cup and on the other hand to a drive and/or torque measuring unit.

It is the object of the invention to provide a rheometer with a compact structure and the smallest possible tolerances in the structure.

The object is achieved according to the invention by the features of independent claim 1. Preferred embodiments of the invention are provided in the dependent claims, which each individually or in combination can represent an aspect of the invention.

In the rheometer according to the invention with the features mentioned in the preamble of claim 1, it is provided that the measuring vessel comprises a sleeve element which extends from the side of the measuring vessel opposite the open side into the interior of the measuring vessel, wherein the shaft extends completely through the sleeve element. In this way, the shaft is passed through the measuring vessel, which makes the structure compact. As mentioned, the shaft extends completely through the sleeve element, so that it is connected to the measuring body via the open side. The test substance is to be understood as the sample whose deformation and/or flow behavior is to be examined.

According to a preferred embodiment of the invention it is provided that the rheometer comprises a drive and/or torque measuring unit connected to the shaft and arranged on the side of the measuring vessel opposite the open side. This unit can be arranged on this opposite side directly at the measuring vessel, which makes the structure quite compact.

According to a further preferred embodiment of the invention, the cavity (for receiving the test substance) completely or at least partially encompasses the sleeve element circumferentially. In order to achieve that the cavity completely encompasses the sleeve element circumferentially, the measuring vessel has a shape similar to a crown cake baking pan.

According to yet another preferred embodiment of the invention, it is provided that the measuring body partially or completely encompasses the sleeve element circumferentially.

In a further preferred embodiment of the invention it is provided that the shaft is releasably connected to the measuring body. The releasable connection can be a screw connection, for example.

In yet another preferred embodiment of the invention, it is provided that the measuring vessel is configured rotationally symmetrical.

In the following, the invention is explained by way of example with reference to the attached drawing based on a preferred exemplary embodiment, wherein the features shown below can represent an aspect of the invention both individually and in combination. In the drawing:

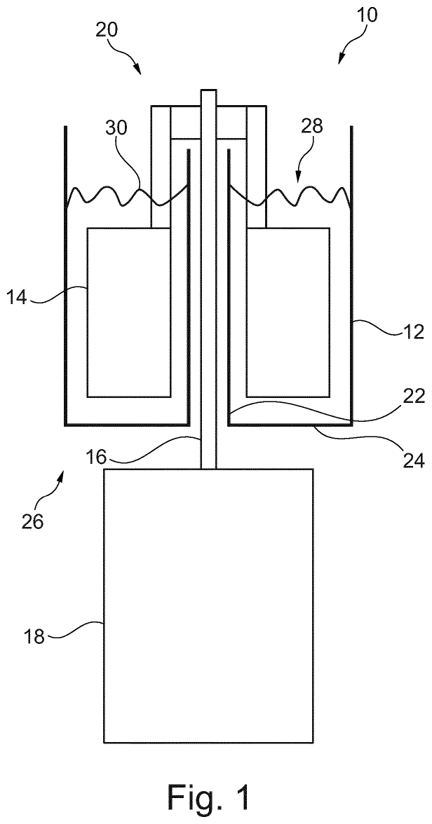

FIG. 1 shows a rheometer according to a preferred embodiment of the invention in a sectional view.

FIG. 1 shows a rheometer 10 comprising a measuring vessel 12, a measuring body 14, a shaft 16 and a drive or torque measuring unit 18. The measuring vessel 12 is a measuring vessel 12 open to one side 20, which in turn comprises a cylindrical outer shape and a sleeve element 22 arranged in the interior of the measuring vessel 12. Said sleeve element 22 extends from a bottom 24 of the measuring vessel 12 on the side 26 opposite the one side 20 close to the opening of the measuring vessel 12. In the interior of the measuring vessel 12 a cavity 28 for receiving a test substance 30 to be examined (which can also be designated as a sample) is formed. The sleeve element 22 forms a passage for the shaft 16, which is connected on the one hand to the drive or torque measuring unit 18 and on the other hand to the measuring body 14. The shaft 16 extends from one side to the other side 20, 26 of the measuring vessel, wherein it completely extends through the sleeve element 22.

The drive or torque measuring unit 18 is optionally a motor or a load cell. Correspondingly, with respect to the measuring body 14, the shaft 16 serves as a drive shaft for transmitting a torque from the drive unit 18 (motor) to the measuring body 14 or as an output shaft for transmitting a torque from the measuring body 14 to the torque measuring unit 18 (load cell).

The drive or torque measuring unit 18 is arranged on the side 26 of the measuring vessel 12 opposite the opening of the measuring vessel 12, that is below the measuring vessel 12. The shaft 16 extends through the measuring vessel 12 to the side 20 of the vessel 12 at which the opening is located, that is to say the top side of the measuring vessel. There, the shaft 16 is releasably connected to the measuring body 14. The measuring body 14 is formed, for example, as a measuring paddle or as a measuring cylinder.

### REFERENCE SYMBOLS

10 rheometer
12 measuring vessel
14 measuring body
16 shaft
18 drive or torque measuring unit
20 one side
22 sleeve element
24 bottom
26 opposite side
28 cavity
30 test substance

1. Rheometer (10) for determining the deformation and/or flow behavior of a test substance (30), comprising:
a measuring vessel (12) which is open towards one side (20) and which forms a cavity (28) in its interior for receiving the test substance (30);
a measuring body (14) disposed within this cavity (28); and
a shaft (16) connected to the measuring body (14) via the open side (20);
characterized in that
the measuring vessel (12) comprises a sleeve element (22) which extends from the side (26) of the measuring vessel (12) opposite the open side (20) into the interior of the measuring vessel (12), wherein the shaft (16) extends completely through the sleeve element (22).

2. Rheometer according to claim 1, characterized by a drive and/or torque measuring unit (18) which is connected to the shaft (16) and is arranged on the side (26) of the measuring vessel (12) opposite the open side.

3. Rheometer according to claim 1 or 2, characterized in that the cavity (28) completely encompasses the sleeve element (22) circumferentially.

4. Rheometer according to any one of claims 1 to 3, characterized in that the measuring body (14) partially or completely encompasses the sleeve element (22) circumferentially.

5. Rheometer according to any one of claims 1 to 4, characterized in that the measuring body (14) is configured as a measuring paddle or as a measuring cylinder.

6. Rheometer according to any one of claims 1 to 5, characterized in that the shaft (16) is releasably connected to the measuring body (14).

7. Rheometer according to any one of claims 1 to 6, characterized in that the measuring vessel (12) is configured rotationally symmetrical.
